(19) United States
(12) Patent Application Publication
(10) Pub. No.: US 2007/0047773 A1
(43) Pub. Date: Mar. 1, 2007

(54) Digital processing of an iris image

(75) Inventors: Lionel Martin, Aix-en-Provence (FR); Guillaume Petitjean, Aix-en-Provence (FR); William Ketchantang, Marseille Cedex (FR)

Correspondence Address: STMicroelectronics Inc.;c/o WOLF, GREENFIELD & SACKS, PC, Federal Reserve Plaza, 600 Atlantic Avenue, BOSTON, MA, 02210-2206, US

(73) Assignees: STMicroelectronics S.A., Montrouge (FR); Universite Paul Cezanne Aix Marseille III, Aix-En-Provence (FR)

(21) Appl. No.: 11/512,906

(22) Filed: Aug. 30, 2006

(30) Foreign Application Priority Data
Aug. 31, 2005 (FR) 05/52617

(51) Int. Cl. G06K 9/00

(52) U.S. Cl. 382/117

(57) ABSTRACT

A method of digital processing of an image of the iris of an eye or the like, including at least a first filtering step corresponding to a morphological closing by a first structuring element corresponding to a disk having a radius in number of pixels approximately corresponding to the thickness of an eyelash in the image, and a second filtering step corresponding to a morphological opening of the image resulting from the previous step by a second structuring element corresponding to a disk having a radius in number of pixels ranging between two and five times that of the disk of the first step.

### BACKGROUND OF THE INVENTION

1. Field of the Invention

The present invention generally relates to digital image processing and, more specifically, to processing of digital images of an eye in identification or authentication applications.

2. Discussion of the Related Art

Iris recognition is a satisfactory biometric identification technique, provided that the image on which the analysis and identification processes are applied is an exploitable image. In particular, the performance of recognition algorithms depends strongly on the sharpness of the image of the iris to be identified.

Currently, in most applications, and especially in so-called “embarked” applications (for example, for controlling the access to a portable telephone or computer, for an electronic key, etc.), the camera used (digital sensor and lens) has no autofocus system adjusting the focal length (real or simulated) according to the distance.

Further, to obtain a sufficient resolution of the iris with optics with no specific focal length, the images are taken at a relatively short distance (generally on the order of from 10 to 30 cm). This results in a short depth of focus (distance range between the camera and the eye in which the image is sharp). This short depth of focus added to the fact that the eye is spherical may generate sharpness differences in the areas of a same image of the eye.

A processing prior to the actual iris recognition is thus often implemented to select a sufficiently sharp image. Generally, the shooting device takes a number of images ranging between 5 and 50 and the preprocessing system selects one or several images to be submitted to the actual recognition algorithm.

An example of a method for evaluating the sharpness of the image of the iris of an eye for subsequent recognition is described in document US-A-2004/0101170.

However, when images are of poor quality (out-of-focus images, blurred images due to the eye motions, to the quality of the optical system, presence of eyelashes in the iris, occurrence of white spots in the pupil due to the reflections of a light source, etc), the method for selecting the sharpest images nevertheless selects images which are insufficient for an acceptable recognition, and in particular for a localization.

### SUMMARY OF THE INVENTION

The present invention aims at overcoming all or part of the disadvantages of known solutions for preprocessing digital images for an iris recognition.

The present invention more specifically aims at providing a digital preprocessing of an iris image to improve the iris localization, especially so that a downstream identification algorithm is less sensitive to differences between the original qualities of the images.

The present invention also aims at providing a solution compatible with embarked systems, especially in terms of used calculation resources.

To achieve all or part of these objects as well as others, the present invention provides a method of digital processing of an image of the iris of an eye or the like, at least comprising:

a first filtering step corresponding to a morphological closing by a first structuring element corresponding to a disk having a radius in number of pixels approximately corresponding to the thickness of an eyelash in the image; and

a second filtering step corresponding to a morphological opening of the image resulting from the previous step by a second structuring element corresponding to a disk having a radius in number of pixels ranging between two and five times that of the disk of the first step.

According to an embodiment of the present invention, the first and second steps are followed by:

a third filtering step corresponding to a morphological opening of the image resulting from the second step by a third structuring element corresponding to a disk having a radius corresponding to the minimum expected size of the pupil in the iris; and

a fourth filtering step corresponding to a morphological closing by the third structuring element.

According to an embodiment of the present invention, the order of the third and fourth steps is inverted.

According to an embodiment of the present invention, a fifth step comprises the application of a contrast enhancement algorithm, preferably by a piecewise linear stretch filtering.

According to an embodiment of the present invention, the resulting image is provided to an iris localization operator.

The present invention also provides a method for recognizing the iris of an eye.

The present invention also provides a system for recognizing the iris of an eye.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1 very schematically shows in the form of blocks an embodiment of an iris recognition system implementing the preprocessing method of the present invention;

FIG. 2 very schematically shows in the form of blocks an embodiment of the preprocessing method according to the present invention;

FIG. 3 illustrates an embodiment of a morphological filtering step of the method of FIG. 2;

FIGS. 4A to 4C, 5A to 5C, and 6A to 6C illustrate experimental results obtained by the implementation of the method of FIG. 3.

### DETAILED DESCRIPTION

For clarity, only those method steps and elements which are useful to the understanding of the present invention have been shown in the drawings and will be described hereafter. In particular, the actual iris localization and recognition steps exploiting the preprocessing of the present invention have not been described in detail, the present invention being compatible with any downstream exploitation of the preprocessed images. Similarly, the mode by which the images to be processed by the present invention are obtained has not been described in detail, the present invention being here again compatible with any eye digital image obtained in levels of grey.

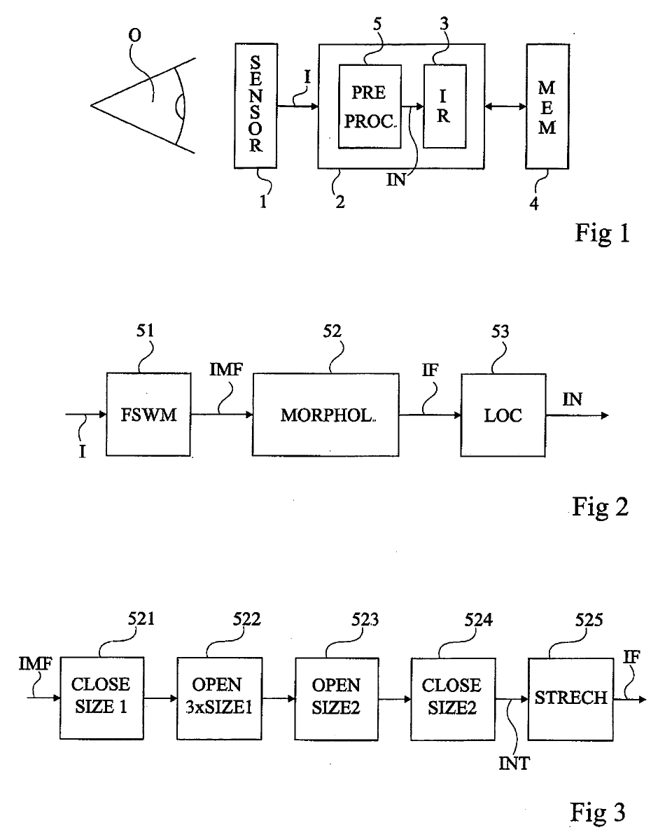

FIG. 1 very schematically shows in the form of blocks an embodiment of an iris recognition system implementing the method of the present invention.

Such a system is intended to exploit eye images to perform an identification or authentication by iris recognition. For example, a digital sensor 1 (SENSOR) acquires a video sequence of an eye O of a subject. The number of saved images I preferably is at least some ten to reduce or minimize the risk of having to ask the subject to submit to a new series of shootings. As a variation, the images to be analyzed result from a distant source and may be prerecorded.

Sensor 1 is connected to a central processing unit 2 especially having the function of implementing the actual-iris recognition (block 3, IR) after having selected, from among a set of images stored in a memory 4 (MEM), the sharpest image IN (or the sharpest images).

FIG. 2 illustrates, in blocks, an embodiment of a preprocessing phase 5 according to the present invention. In this example, each image I is submitted to an operator 51 (FSWM) known as a “frequency selective weighted median” operator. This operator is optional and is used in this example to select the best images of the video sequence taken by sensor 1 (FIG. 1). Such an FSWM operator may be replaced with any other adapted processing, or even be omitted, especially if the processing of the present invention is applied to prerecorded images.

Images IMF (or images I in the absence or an operator 51) are processed by a so-called morphological or contrast enhancement step 52 (MORPHOL) which will be subsequently detailed in relation with FIG. 3.

A morphological filtering amounts to filtering an image in grey levels, not by applying convolution operation, but according to the size and to the shape of the image details (in practice, by applying operations of determination of maximum and minimum values in a specific neighborhood of each pixel). A morphological filtering is particularly well adapted when shapes (here, the iris and pupil contours) are considered. A so-called structuring element (generally, a circle, a square, or a hexagon) is used as a reference. According to whether the maximum or minimum values are searched, it is spoken of erosion or expansion. For example, an erosion eliminates light spots on a dark background if these spots have a size smaller than that of the structuring element. Conversely, a dark spot (of a size smaller than that of the structuring element) on a light background will be reduced by an expansion. To respect the general shapes of the image, the erosion and expansion operations are generally combined. It is spoken of an opening to designate an erosion followed by an expansion with the same structuring element and of a closing to designate an expansion followed by an erosion with the same structuring element. A closing suppresses dark details of small size with respect to the structuring element. An opening suppresses light details of small size with respect to the structuring element.

Examples of morphological filters are described in:

“Statistical Evaluation of Sequential Morphological Operations” by Motaz A Mohamed and Jafar Saniie, IEEE Transactions on Signal Processing, vol. 43, n°7, July 1995;

“Filtrage Morphologique” by J. Serra, Ecole des Mines de Paris, 2000;

“Algorithms for the Decomposition of Gray-Scale Morphological Operations” by R. Jones and I. Svalbe, IEEE Transaction on Pattern Analysis and Machine Intelligence, 1994; and

“Morphologie Mathématique et Analyse d'Images” by C. Vachier, Université Paris 12, 2002.

Each of these references is incorporated herein by reference.

In the example of FIG. 2, images IF resulting from step 52 are submitted to a step 53 (LOC) of iris localization. Iris localization methods are described in, for example, documents US-A-2004/0101169 (02-RO-406) and US-A-2004/0101170 (02-RO-308), which documents are incorporated herein by reference.

The images IF resulting from block 52 are submitted to a step 53 of selection of the sharpest image from a set of images, then of localization of the iris in this image.

FIG. 3 shows a preferred embodiment of filtering phase 52 of FIG. 2. Image IMF provided by filter 51 is preferably submitted to five steps 521 to 525. The first four steps are morphological opening or closing steps.

The selection of the structuring elements used for the opening and closing filterings of course conditions the obtained results. The structuring element for example corresponds to a white spot in an image, the expected size of the iris, of an eyelash, etc.

According to the preferred embodiment of the present invention, a first step 521 (CLOSE SIZE1) comprises the closing by filtering of image IMF with a structuring element corresponding to a disk with a diameter approximately corresponding to the thickness of an eyelash. According to a specific example of a 640-by-480 pixel image, the structuring element is selected to have a 5-pixel radius. Step 521 being a closing, eyelashes are eliminated since they are relatively dark.

A second step 522 (OPEN 3*SIZE1) comprises an opening of a size ranging between twice and five times the size (first size) of the element of step 521, preferably approximately three times this first size. This size actually corresponds to that of the white spots in the image. Considering the previous example, a 15-pixel radius is selected for the structuring element of opening 522. This first opening partially eliminates white spots.

Preferably, the first two steps are followed by two other opening and closing steps (or conversely). In the shown example, a third step 523 is an opening (OPEN SIZE2) of a structuring element corresponding to a disk having a radius corresponding to the minimum expected radius of the pupil in the image. For example, size SIZE2 is on the order of 30 pixels in the considered images. This second optional opening entirely suppresses white spots and homogenizes the pupil area.

A fourth step 524 comprises a closing (CLOSE SIZE2) of same structuring element size as step 523 to homogenize the iris area of the image which comprises a few dark areas generated by the previous step. Image INT resulting from step 524 is an image in which the white spots present in the original images have been suppressed, as well as the eyelashes which cover a portion of the iris.

However, the constrast risks being attenuated. Accordingly, in a preferred embodiment, a fifth step 525 (STRETCH) enhances the contrast of the image resulting from the previous step to provide image IF.

Different contrast enhancement algorithms may be used. According to a preferred example, the present invention provides implementing a contrast enhancement comprising a linear piecewise stretching. This amounts to adjusting the histogram of the grey levels of the image within a bounded interval, defined by the minimum and maximum intensity values desired in the final image. An intensity distribution on the different regions present in the image almost identical from one image to another is thus obtained, whatever the luminosity of the original image.

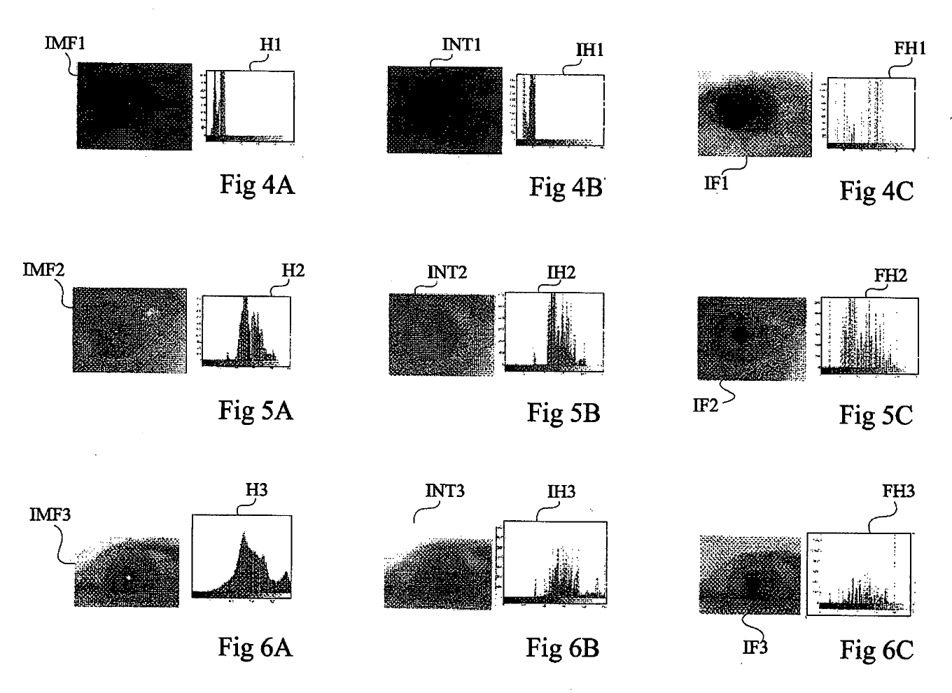

FIGS. 4A to 4C, 5A to 5C, 6A to 6C illustrate experimental results obtained by implementing the method of FIG. 3 on three eye images.

FIGS. 4A, 5A, and 6A show original images IMF1, IMF2, and IMF3, respectively arbitrarily considered as dark, correct (with a light white spot) and polluted by eyelashes and white spots, with their respective histograms H1, H2, and H3 of grey level intensities. The grey scales taken as an example are arbitrary but identical for all histograms to enable comparison thereof.

FIGS. 4B, 5B, and 6B show respective images INT1, INT2, and INT3 obtained at the output of the second morphological closing 524 and their associated grey level histograms IH1, IH2, and IH3.

FIGS. 4C, 5C, and 6C show the respective processed high-contrast images IF1, IF2, and IF3, obtained at the output of step 525 and their associated grey level histograms FH1, FH2, and FH3.

As shown in these drawings, the linear stretching contrast enhancement step improves the contrast between the pupil and iris regions and between the iris and cornea regions. The result is mostly striking for the dark image (FIGS. 4A to 4C). The morphological filtering steps eliminate the eyelashes (melt the eyelashes in the image) and the white spots.

An advantage of the present invention is that it creates homogeneous contrasted regions in the image, whereby a better efficiency of the iris localization unit is obtained.

Another advantage of the present invention is that the morphological filtering and linear histogram stretching steps are compatible with the calculation resources of “embarked” applications and with the required rapidity for real-time iris recognitions.

Of course, the present invention is likely to have various alterations, improvements, and modifications which will readily occur to those skilled in the art. In particular, the implementation of the present invention with hardware and/or software tools is within the abilities of those skilled in the art based on the functional indications given hereabove. Similarly, the sizes of the structuring elements of the morphological filters of the present invention may be modified according to the size of the eyelashes, of the white spots, and of the pupil in the images.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method of digital processing of an image of the iris of an eye or the like, comprising:
a first filtering step corresponding to a morphological closing by a first structuring element corresponding to a disk having a radius, the number of pixels of which approximately corresponds to the thickness of an eyelash in the image; and
a second filtering step corresponding to a morphological opening of the image resulting from the previous step by a second structuring element corresponding to a disk having a radius, the number of pixels of which ranges between two and five times that of the disk of the first step.

2. The method of claim 1, wherein the first and second steps are followed by:
a third filtering step corresponding to a morphological opening of the image resulting from the second step by a third structuring element corresponding to a disk having: a radius corresponding to the minimum expected size of the pupil in the iris; and
a fourth filtering step corresponding to a morphological closing by the third structuring element.

3. The method of claim 2, wherein the order of the third and fourth steps is inverted.

4. The method of claim 2, wherein a fifth step comprises the application of a contrast enhancement algorithm, preferably by a piecewise linear stretch filtering.

5. The method of claim 1, wherein the resulting image is provided to an iris localization operator.

6. A method for recognizing the iris of an eye, implementing a preprocessing corresponding to the method of claim 1.

7. A system for recognizing the iris of an eye, comprising means for implementing the method of claim 6.
